(19) United States
(12) Patent Application Publication
(10) Pub. No.: US 2025/0331675 A1
(43) Pub. Date: Oct. 30, 2025

(54) TABLET FOR THE EXTRACTION OF A BEVERAGE AND METHOD FOR THE PRODUCTION THEREOF

(71) Applicant: LUIGI LAVAZZA S.P.A., Torino (IT)

(72) Inventor: Massimiliano CARRACOI, Torino (IT)

(73) Assignee: LUIGI LAVAZZA S.P.A., Torino (IT)

(21) Appl. No.: 18/879,917

(22) PCT Filed: Jul. 20, 2023
(86) PCT No.: PCT/IB2023/057387

§ 371 Date: Dec. 30, 2024

(30) Foreign Application Priority Data
Jul. 22, 2022 (IT) 102022000015474

(51) Int. Cl. A47J 31/44; A23F 3/32; A23F 5/12

(52) U.S. Cl. CPC A47J 31/4492; A23F 3/32; A23F 5/125

(57) ABSTRACT

A tablet for extraction of a beverage, formed by cohesion of a dosed amount of a precursor substance in granular or powder form has a reference surface with one or more graphic recognition markings adapted to provide protection from abrasion of the precursor substance, and optionally a higher degree of cohesion, in a region where the one or more graphic recognition markings are formed compared to a region of the reference surface devoid of the graphic recognition markings. A method for producing a tablet for extraction of a beverage, the tablet being formed of a dosed amount of a precursor substance in granular or powder form, involves forming a tablet with self-supporting structure, and making graphic recognition markings on a reference surface of the tablet, adapted to provide protection from abrasion of the precursor substance in a region of the reference surface where the graphic recognition markings are formed.

### CROSS-REFERENCE TO RELATED APPLICATIONS

This application is a National Phase Application of PCT International Application No. PCT/IB2023/057387, having an International Filing Date of Jul. 20, 2023, claiming priority to Italian Patent Application No. 102022000015474, filed Jul. 22, 2022 each of which is hereby incorporated by reference in its entirety.

### FIELD OF THE INVENTION

The present invention relates to the preparation and delivery of hot beverages by controlled infusion of a dose unit, particularly a tablet, of a precursor substance containing one or more ingredients, e.g., coffee.

More specifically, the present invention relates to a tablet for extracting a beverage, the tablet being formed by cohesion of a dosed amount of at least one precursor substance in granular or powder form, and having at least one reference surface with one or more graphic recognition markings, and a method for producing such tablet.

### BACKGROUND OF THE INVENTION

Machines for the preparation and dispensing of hot beverages by controlled infusion of a dose unit are known which comprise means for automatically identifying the dose unit introduced into the machine for the purpose of classifying said dose unit into one of a plurality of predetermined types or classes of dose units and consequently controlling at least a parameter or an operating mode of the infusion of the machine according to the type of dose unit recognized, or recording and/or transmitting an item of data on machine usage to a remote management system.

The automatic identification may be implemented with machine learning techniques, such as through pattern recognition methods or artificial neural networks based on predefined classification schemes.

The utility model IT274555 of the same Applicant describes a machine for the preparation of beverages, in particular coffee, using a pod or capsule selected from a plurality of types of pods or capsules having different characteristics, in particular having the same dimensional characteristics but containing different substances or ingredients, the machine comprising a detecting device capable of detecting at least one predetermined detectable characteristic or code identifying the type of pod or capsule introduced into the machine, and a processing and control unit to which said detecting device is connected, which is arranged to implement a variable operation cycle of the machine according to predetermined modes depending on the type of pod introduced into the machine and recognized through the detecting device and/or to acquire data indicative of the user's mode of use of the machine, such as the total amount and/or individual amounts of the various types of pods used in a given period of time, the possible use of compatible non-“original” pods, etc.

The detectable feature or code is, for example, a color, or a bar code, or a so-called RFID tag.

The automatic identification of the dose unit may also be implemented by machine learning techniques, such as by pattern recognition methods or artificial neural networks based on predefined classification schemes, as taught by the international patent application WO 2019/154527.

WO 2019/154527 describes a machine for preparing and dispensing a beverage, such as tea, coffee, hot chocolate, cold chocolate, milk, soup, or baby food, comprising a module for recognizing a capsule inserted into said machine at a recognition position, and comprising a camera for capturing an image of at least part of said capsule and a neural network computing device configured to determine the type of capsule from among a plurality of predefined capsule types based on an image of at least part of said capsule captured by said camera.

The various types of dose units include capsules, pods, and tablets (or pastilles). In the case of tablets, the precursor substance in granular or powder form is compacted and made cohesive to form a homogeneous body of a predetermined shape, having a self-supporting structure, whereby no external wrappings or packages are used to contain the substance.

The Italian patent applications 102020000021496 and 102020000021499 by the same Applicant indicate, by way of example, respective methodologies and systems for the preparation of high quality, more production-efficient tablets (or pastilles).

Any identifying information about the type of tablet, i.e., by way of example, the ingredient or mixture of ingredients constituting it or the manufacturer, is therefore necessarily reproduced, e.g., by means of one or more colors or graphic recognition markings or similar representations, on at least one surface of the tablet.

Disadvantageously, a tablet is likely to change its features over time as it is subject to deterioration as a result of, for example, storage or transportation conditions, or exposure to environmental conditions of suboptimal temperature or humidity, or even its handling by a user.

### SUMMARY OF THE INVENTION

This circumstance affects the accuracy of the automatic classification that may be conducted from the information conveyed by said tablet.

The object of the present invention is to provide a satisfactory solution to this problem, namely to make a tablet and provide a method for its production that are able to avoid possible alterations of the information conveyed by the tablet in order to ensure the accuracy of automatic recognition and classification of the type of tablet conducted by a machine for the preparation of beverages, particularly coffee.

According to the present invention, this object is achieved by a tablet as described and claimed herein.

Particular embodiments form the subject matter of the dependent claims, the content of which is to be understood as an integral part of the present description.

The invention further pertains to a method for producing the tablet described and claimed herein.

In summary, the present invention is based on the principle of making a tablet by aggregation of a dosed amount of at least one precursor substance in granular or powder form, wherein the precursor substance exhibits a greater protection from abrasion, such as a greater degree of cohesion, at one or more graphic recognition markings than at the region of the surface of the precursor substance that is devoid of said graphic markings. Advantageously, making said graphic markings confers protection from abrasion to, and preferably results in a greater degree of cohesion of, the precursor substance in the region where the graphic markings are formed, i.e., the operation of “writing” the graphic markings coincides with the treatment that provides greater adhesion or abrasion resistance to the precursor substance.

In this way, the graphic recognition markings are likely to deteriorate to a lesser extent, ensuring their correct recognition when captured by camera means and automatically classified according to their optical and/or morphological properties.

In this way, in particular, the tablet is adapted to be subjected to recognition through the use of a reading device for scanning the recognition markings or an image capture device and machine learning classification techniques, preferably through a neural network or similar determined classification model, integrated into a machine for preparing and dispensing a beverage from the tablet of precursor substance, wherein the classification is based on a set of training images of the tablet representative of a plurality of predetermined types or classes of tablets, e.g. comprising a plurality of images of tablet samples pre-classified in a supervised manner, possibly under a plurality of image acquisition conditions of said tablets.

The graphic recognition markings are placed on at least one surface of the tablet, e.g., for tablets with an overall cylindrical or prismatic shape, on one or more among a base face, both opposite base faces, the side surface, or one or more side faces, with possible redundancies i.e., repetition of the graphic markings on more than one face (e.g., on both base faces or front/back of the tablet) or on the same face. The surface or surfaces on which the graphic markings are affixed are referred to hereinafter as reference surfaces.

Advantageously, the graphic recognition markings representative of the dose unit types comprise an identifying inscription of the product line and additional denotation markings, allowing a first classification on the basis of the tablet product line and a second classification on the basis of the mixture of the precursor material or on the basis of tablet size, of the amount of precursor material, type and/or volume of the beverage.

The term “graphic markings” means surface (two-dimensional) graphic markings obtainable by, for example, printing or other deposition technique or application of a layer of negligible thickness, e.g., a film, of an additional substance (such as an edible ink) which is edible or otherwise adapted for food use, hot marking, or by application of a localized laser beam, said markings exhibiting a color different from the color of the precursor substance of the dose unit or a color contrasting with the color of the precursor substance, or otherwise a different light intensity or brightness than the light intensity or brightness of the precursor substance in response to illumination of the tablet by the reading or imaging device, or raised or deep (three-dimensional) graphic markings obtained by modifying the morphological properties of the surface of the precursor substance of the tablet, e.g., by localized deposition or application of a layer of additional substance which is edible (such as an edible ink) or otherwise adapted for food use, of non-negligible thickness, or by mechanical and/or thermal impression on predetermined areas of the surface of the precursor substance adapted to form reliefs or engravings, which have a color different from the color of the precursor substance of the dose unit or a color contrasting with the color of the precursor substance, or otherwise a different light intensity or brightness than the light intensity or brightness of the precursor substance in response to the tablet being illuminated by the reading device or imaging device, or which exhibit modified reflection properties and/or shadows when illuminated. In a combination of techniques, a layer of negligible thickness, such as a film, of an additional substance which is edible (such as an edible ink) or otherwise adapted for food use may be laid or applied to the bottom of an engraving.

In all these cases, the additional edible or food-grade substance in general may exhibit properties of strong adhesion to the precursor substance of the tablet, whereby it does not separate from it under any infusion and tablet processing conditions, or it may be separable from the tablet under the infusion conditions so that it becomes part of the composition of the beverage. In the latter case, the additional edible substance may be sugar, chocolate, or the like, and appear, for example, in the form of a glaze adapted for dissolving in the brewing process and mixing with the brewing liquid to sweeten or add flavor to the beverage.

In one embodiment, the automatic recognition of tablets (or pastilles) may be achieved by identifying, in the acquired images, the graphic recognition markings and determining a comparison index representative of the degree of similarity between the graphic recognition markings (or parts thereof) of the acquired image and the graphic recognition markings (or parts thereof) of the training images of tablets (or pastilles) or a set of images of classes of reference tablets (or pastilles). The degree of similarity is defined by a comparison threshold or multiple comparison thresholds, which are preferably dynamically modifiable during the life cycle of the machine for the preparation and brewing of coffee.

More generally, several techniques may be adopted for the identification of graphic recognition markings.

It is also possible to provide for automatic recognition of tablets (or pastilles) to be implemented subsequently to a correction process of the acquired images as a result of a deterioration in classification accuracy or in the degree of similarity in comparisons between the graphic recognition markings of the acquired image and the graphic recognition markings of the images of training tablets (or pastilles) or a set of images of reference tablet (or pastille) classes, or even on the basis of the elapsed operating time of the machine or of the number of beverages dispensed. The image correction process may be implemented by applying predetermined correction models, or updating characteristic parameters, of the classification model according to instructions received from an external management system temporarily connected to the control system of the machine via local wired connection or remote wireless connection.

### BRIEF DESCRIPTION OF THE FIGURES

Further features and advantages of the invention, and the applications thereof, will be presented in greater detail in the following detailed description, given by way of non-limiting example, with reference to the accompanying drawings, wherein:

FIG. 1 is a schematic representation, in cross-section, of a machine for preparing and dispensing hot beverages by infusion, according to the prior art;

FIG. 2a-2c are illustrative representations of coffee tablets (or pastilles) bearing graphic recognition markings;

FIG. 3a-3d are illustrative cross-sectional representations of the coffee tablet (or pastille) in FIG. 2a according to the line III-III, wherein the graphic recognition markings are made according to different techniques;

FIGS. 4a and 4b illustratively show a succession of operations for making two-dimensional graphic recognition markings according to a first technique;

FIGS. 5a and 5b illustratively show a succession of operations for making two-dimensional graphic recognition markings according to a second technique;

FIGS. 6a and 6b illustratively show a succession of operations for making two-dimensional graphic recognition markings according to a third technique;

FIGS. 7a and 7b illustratively show a succession of operations for making three-dimensional graphic recognition markings according to a fourth technique;

FIGS. 8a and 8b illustratively show a succession of operations for making three-dimensional graphic recognition markings according to a fifth technique;

FIGS. 9a and 9b illustratively show a succession of operations for making three-dimensional graphic recognition markings according to a sixth technique; and

FIG. 10 is an illustrative block diagram of a control system for a machine for preparing and dispensing hot beverages by infusion, operating with the tablets (or pastilles) covered by the invention.

### DETAILED DESCRIPTION

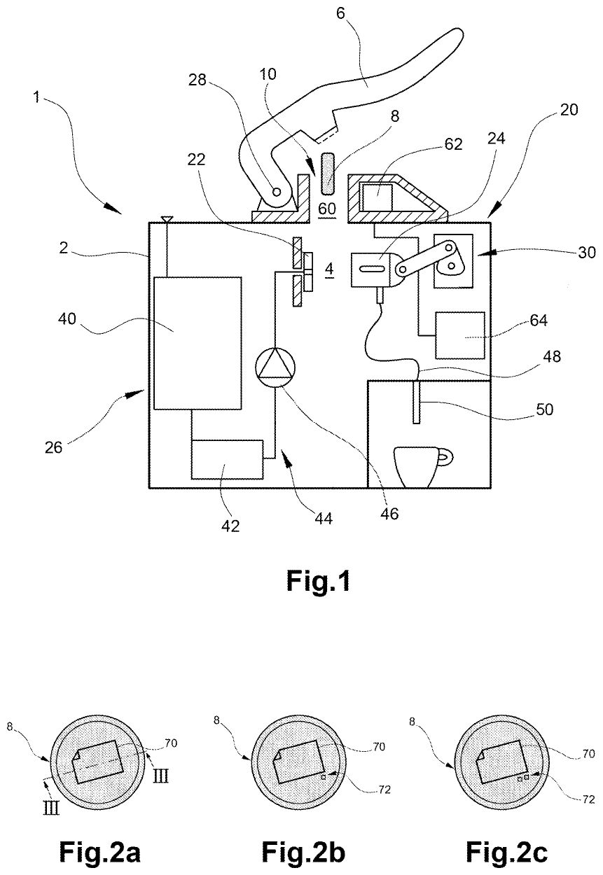

Referring to FIG. 1, a machine for the preparation of beverages, in particular coffee, from a compacted tablet or pastille containing one or more ingredients, in particular coffee powder, is collectively denoted as 1.

In the example embodiment shown, the machine 1 comprises a machine body 2 with an operating region 4. The machine 1 has a lever 6 to push a tablet 8 into the region 4 through an introduction opening 10, a closure device 20 operating on the tablet 8 to enclose it in an infusion chamber delimited by two opposing cooperating elements 22, 24, and a circulation system 26 to circulate a flow of hot water and/or pressurized steam through the tablet into the infusion chamber.

The tablet 8 is formed by cohesion of a dosed amount of at least one precursor substance in granular or powder form, such as coffee or other substance intended for infusion to produce a hot beverage, so that it presents a self-supporting structure that does not require an outer casing.

The lever 6 is rotatable around a fulcrum 28 and adapted to push the tablet 8 toward the operating region 4 through the opening 10.

In the example shown, the closure device 20 includes an abutment element 22, a thrust element 24, movable relative to the abutment element 22, and a clamping assembly 30 operating on the element 24 to move it along a sliding direction.

The element 24 comprises a cup-shaped body defining the infusion chamber adapted to accommodate the tablet 8, in a manner known per se.

The circulation system 26 is also of a type that is essentially already known and comprises a water tank 40, a boiler 42, and a hydraulic circuit 44 including a circulation pump 46 between the boiler 42 and an inlet conduit of the abutment element 22. A conduit 48 connects an outlet manifold of the movable thrust element 24 with a beverage dispensing nozzle 50.

The machine 1 further comprises a pre-chamber 60 for the tablet 8 in transit between the introduction opening 10 and operating region 4.

The machine 1 is intended for use with tablets preferably bearing one or more predetermined graphic recognition markings identifying the class to which each tablet belongs, in particular the type of ingredients or substances contained and the type of beverage that they allow to be made, or the product line. These recognition marks are of an optically detectable type, visible on a reference surface of the tablet, e.g. comprising one or more images bearing a product name and denotation markings.

FIG. 2a-2c illustrate by way of example some possible solutions according to which such a tablet 8 may be provided with graphic recognition markings including (at least) an inscription on its outer surface and, in association therewith, denotation markings.

In particular, FIGS. 2a, 2b and 2c show, respectively, tablets 8 bearing an inscription 70, e.g., a cartouche identifying the product line, and zero, one, or two denotation markings 72 associated therewith, in the example case formed by simple symbols (e.g., circles, squares) affixed at a corner of the cartouche, identifying the mixture of the precursor material. In the case of coffee powder, the mixture of the precursor material has a brown color, varying in intensity depending on the composition of the mixture or its storage conditions, while the inscription and denotation markings produced by printing or other application of an additional edible substance, by hot marking, or by application of a localized laser beam or embossing/engraving are of contrasting color, e.g., dark brown or black. Of course, a similar recognition effect may be achieved by making graphic markings of a lighter contrasting color than the background color of the mixture of the precursor material or otherwise having a different light intensity or brightness than the light intensity or brightness of the precursor substance in response to the illumination of the tablet. In certain embodiments, the visibility of graphic markings by contrast with the background of the precursor material may occur at wavelengths of illumination or at wavelengths of observation (reading by scanning recognition markings or image acquisition) different from the spectrum of wavelengths visible to the human eye.

Such tablets 8 may advantageously be used in a machine of the type shown in FIG. 1, where a detector device (reader) 62 is placed along the path of the tablets between the introduction opening 10 and the operating region 4, for example on one side of the pre-chamber 60.

The machine 1 comprises an electronic processing and control unit 64 to which the code detector device 62 is connected and which is arranged to classify the tablet and to implement an operation cycle of the machine for managing the tablet, varying in a predetermined manner according to the class of the tablet 8 introduced into the machine, the image of which tablet is acquired through the code detector device 62, and/or to acquire data indicative of the user's mode of using the machine 1, such as preferred types of beverages, etc.

The processing and control unit 64 may, for example, be arranged to vary, depending on the type of tablet and thus the beverage, the duration of the infusion, and/or the amount and/or temperature and/or pressure of the water and/or steam passed through the tablet.

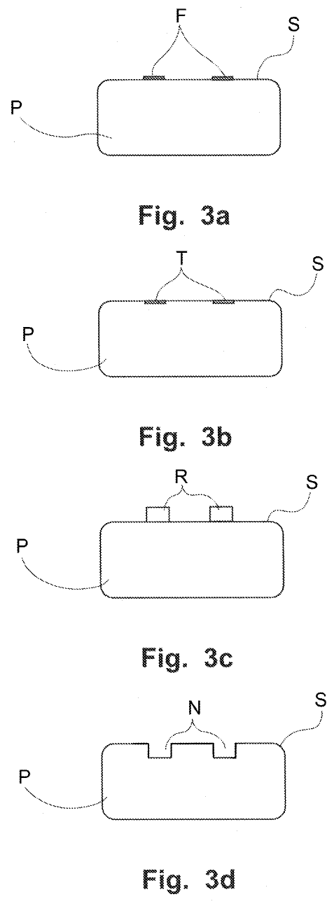

FIG. 3a-3d show, by way of example in a cross-section of the tablet in FIG. 2a according to the line III-III, different embodiments of graphic recognition markings that correspond to different techniques for making said graphic markings.

FIGS. 3a and 3b show respective tablets comprising two-dimensional graphic recognition markings.

FIG. 3a shows a tablet P wherein a film F of an additional edible substance, of negligible thickness relative to the thickness of the tablet, is selectively applied on a reference surface S.

FIG. 3b shows a tablet P wherein a track T of an additional edible substance, of negligible thickness compared to the thickness of the tablet, is selectively made on a reference surface S. The track T may be made using hot marking techniques or the application of a localized laser beam.

FIGS. 3c and 3d show respective tablets comprising three-dimensional graphic recognition markings.

FIG. 3c shows a tablet P wherein a raised formation R is selectively formed on a reference surface S. The raised formation R may be formed by the deposition of a layer of an additional edible substance, such as a glaze.

FIG. 3d shows a tablet P wherein an engraving or recess N is selectively made on a reference surface S. The engraving or recess N may be made by mechanical and/or thermal impression or by simple removal of material.

As a result of each of the preceding techniques, the graphic recognition markings exhibit at least one from among a color different from the color of the reference surface, a color contrasting with the color of the reference surface, or a light intensity or brightness different from the light intensity or brightness of the reference surface in response to an illumination of the reference surface.

In particular, the graphic recognition markings made by relief formations R or engravings N exhibit modified reflection properties and/or shadows in response to an illumination of the reference surface.

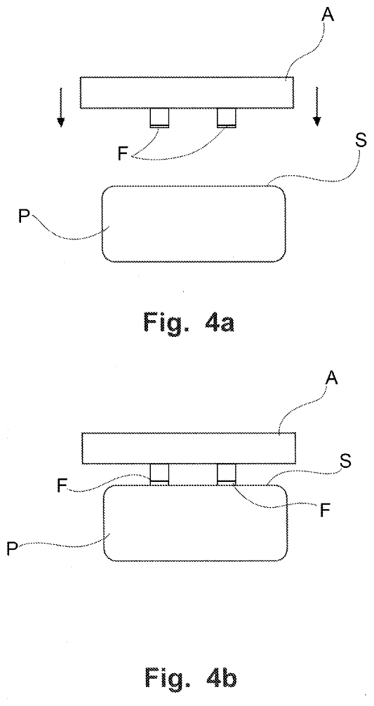

FIGS. 4a and 4b show, by way of example, a succession of operations for making two-dimensional graphic recognition markings by applying a film F of an additional edible substance to a reference surface S of the tablet. An applicator member is denoted with A and has, on one of its lower surfaces in the figure, such as on a die having in relief the shape of the graphic sign to be reproduced, a film F to be affixed to a region where the graphic markings are formed on the reference surface S of the tablet P (FIG. 4a). The transfer of the film F occurs by contact between the applicator member A and the tablet P (FIG. 4b).

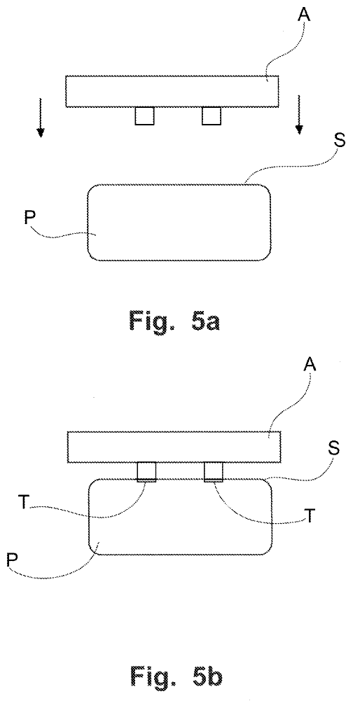

FIGS. 5a and 5b show, by way of example, a succession of operations for making two-dimensional graphic recognition markings by hot marking on a reference surface S of the tablet. An applicator member is denoted by A and has, on one of its lower surfaces in the figure, a die embossed with the shape of the graphic sign to be reproduced, appropriately heated (FIG. 5a). By contact between the applicator member A and the tablet P, sintering of the granular precursor substance of the tablet occurs on a region where the graphic marks are formed on the reference surface S of the tablet P (FIG. 5b).

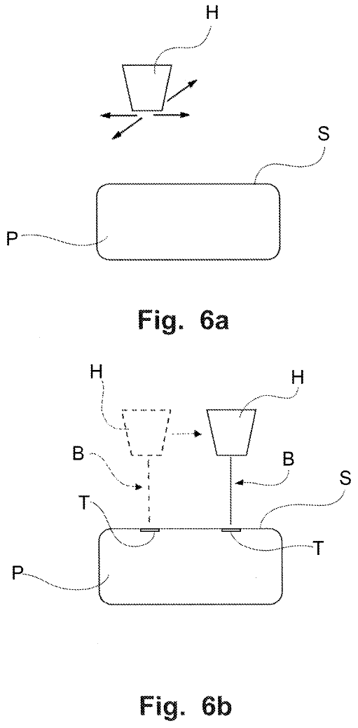

FIGS. 6a and 6b show, by way of example, a succession of operations for making two-dimensional graphic recognition markings by application of a localized laser beam B on a reference surface S of the tablet. A laser processing head is denoted by H and is moved relative to the reference surface S of the tablet P according to a trajectory pattern adapted to represent the shape of the graphic marking to be reproduced (FIG. 6a). The laser beam focused on the reference surface S of the tablet P at a first predetermined power results in the sintering of the granular precursor substance of the tablet on a region where the graphic markings are formed on the reference surface S of the tablet P (FIG. 6b).

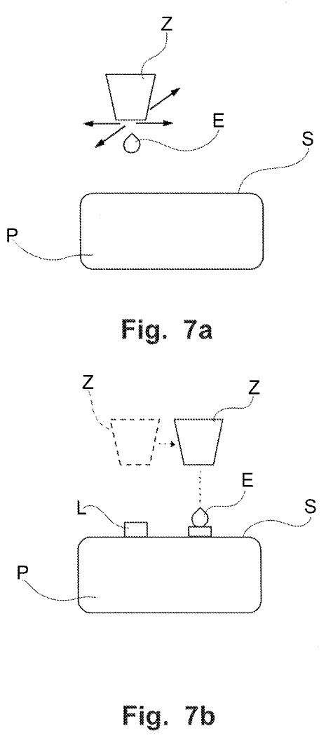

FIGS. 7a and 7b show, by way of example, a succession of operations for making three-dimensional graphic recognition markings by applying a layer L of an additional edible substance to a reference surface S of the tablet. An applicator member is denoted by Z and has a nozzle for the exit of an edible substance E to be affixed to a region where the graphic markings are formed on the reference surface S of the tablet P (FIG. 7a). The applicator member Z is moved relative to the reference surface S of the tablet P according to a trajectory pattern adapted to represent the shape of the graphic marking to be reproduced (FIG. 7b).

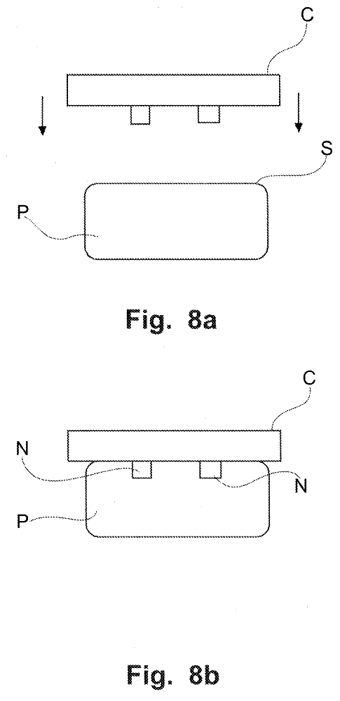

FIGS. 8a and 8b show, by way of example, a succession of operations for making three-dimensional recognition graphic markings by impressing on a reference surface S of the tablet. An impressing member is denoted by C and has, on one of its lower surfaces in the figure, a die embossed with the shape of the graphic marking to be reproduced (FIG. 8a). By pressure between the impressing member C and the tablet P on the reference surface S, mechanical compaction of the granular precursor substance of the tablet occurs on a region where the graphic markings are formed on the reference surface S of the tablet P, corresponding to the recesses N (FIG. 8b).

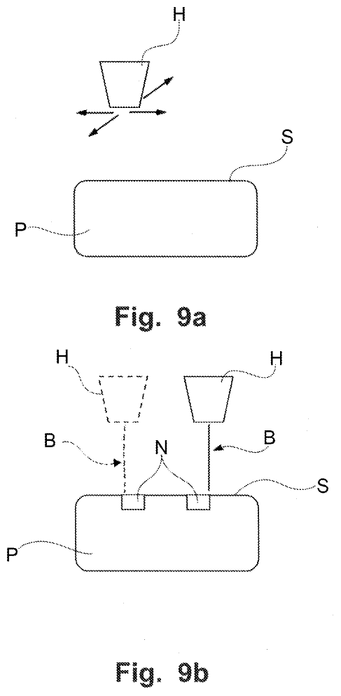

FIGS. 9a and 9b show, by way of example, a succession of operations for making three-dimensional graphic recognition markings by applying a localized laser beam B on a reference surface S of the tablet. A laser processing head is denoted by H and is moved relative to the reference surface of the tablet P according to a trajectory pattern adapted to represent the shape of the graphic marking to be reproduced (FIG. 9a). The laser beam focused on the reference surface of the tablet P, with a variable power at least initially higher than the first predetermined power, results in the engraving of a region where the graphic markings are formed on the reference surface of the tablet P corresponding to the recesses N and the sintering of the granular precursor substance of the tablet around the region where the graphic markings are formed (FIG. 9b).

Advantageously, as a result of the cohesive force of the edible substance forming the film or layer applied being greater than that of the precursor substance of the tablet, as well as the adhesion of the edible substance to the underlying granules of the precursor substance, which are no longer exposed to the surface and thus to the environment and to contact due to handling the tablet, the graphic marking thus formed results in a greater degree of cohesion of the precursor substance in the region where it is formed than in the region of the reference surface of the precursor substance that is devoid of any graphic marking.

Equally advantageously, as a result of mechanical compaction or sintering of the precursor substance of the tablet in the region where the graphic marking is formed, which results in greater adhesion between the granules of the precursor substance, the graphic marking thus formed has a greater degree of cohesion of the precursor substance in the region where it is formed compared to the region of the reference surface of the precursor substance that is devoid of any graphic marking.

In the case of engravings obtained by simple removal of material from the reference surface, the exposure of the precursor substance of the tablet to surface rubbing is nevertheless reduced at the site of the engraving, resulting in an effect fully equivalent to an increase in cohesion.

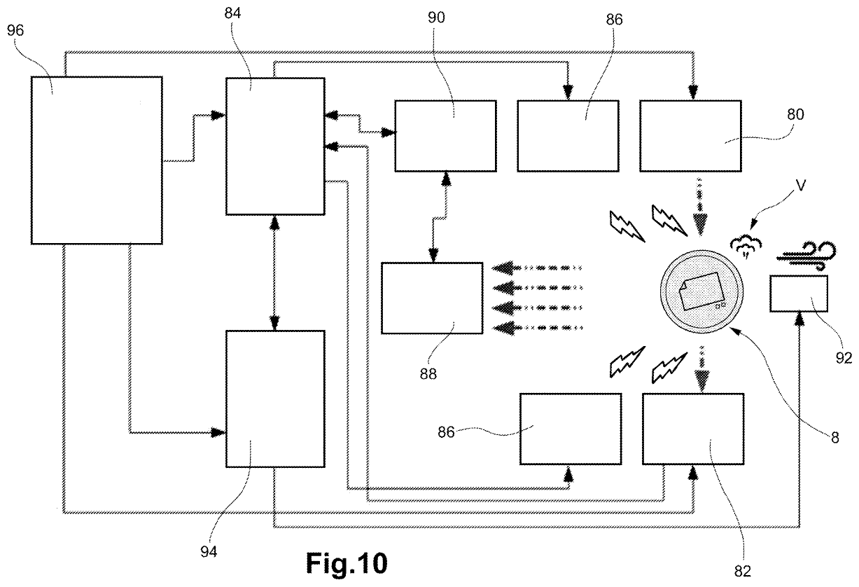

An example control system for the machine in FIG. 1 is illustrated in greater detail by the block diagram in FIG. 10.

The tablet 8 is shown (in the pre-chamber 60) between a pair of devices 80 and 82 adapted to detect its presence, such as by interruption of an infrared signal transmitted from an emitter device 80 to a receiver device 82. An image recognition and classification microcontroller unit 84, in communication with the devices 80 and 82, presides over the detection of the introduction of a tablet into the pre-chamber and is coupled to one or more lighting modules 86 adapted to at least temporarily light the pre-chamber to enable the acquisition of at least one image of at least one reference surface of the tablet. Expediently, it may be envisaged that the lighting modules 86 include means for adjusting the intensity and/or color (or, more generally, wavelength) of the particular illumination light beam.

In general, the illumination light beam may be in the visible spectrum, or in another spectrum, for example infrared or ultraviolet, in one or more selected wavelength bands, with predetermined illumination angles, which are also variable.

Reference numeral 88 denotes an image acquisition module, for example including an RGB camera or a CCD sensor with LED corona illumination, employed to acquire the aforesaid images of the tablet under the control of the microcontroller unit 84, which is arranged to trigger the taking of one or more images of the tablet introduced into the machine during its transfer to the infusion chamber by controlling the illumination modules, as well as to carry out the recognition and classification of the image. The microcontroller unit 84 is coupled to the image acquisition module 88 via an adapter module 90 adapted to transfer the image data to the microcontroller unit 84. The microcontroller unit 84 is programmed to classify detected images according to a predetermined classification and recognition method, e.g. governed by a computer program stored in an associated permanent memory module, which is optionally rewritable as a result of a connection of the microcontroller unit with an update module, e.g., a wired connection with a local update module or a wireless connection, e.g., by means of a local or wide area communication network, with a remote update module, for the purpose of updating a classification and recognition model to new classes of tablets or at different times in the operational life of the machine.

The image acquisition module 88 may operate in the visible spectrum, or in another spectrum, e.g., infrared or ultraviolet, in one or more selected wavelength bands, at least at a predetermined acquisition angle, which is not necessarily frontal, e.g., even variable.

The microcontroller unit 84 is arranged to communicate with separate control means of the machine (not shown) arranged to control at least one parameter or operating management mode of the tablet, such as a parameter or infusion operating mode of the machine or a parameter or operating mode related to other phases, for example for controlling tablet compression during a pre-infusion phase and/or during an infusion phase, according to constant profiles or defined according to predetermined control curves, tablet squeezing after infusion to eliminate residual water, automatic tablet removal after infusion from the infusion chamber to a collection compartment of spent tablets, depending on the recognized tablet class, according to the relevant data transmitted by the adapter module 90, or for communicating with a remote management system set up to record machine usage data, e.g., to count the number of dispensed beverages for statistical purposes and to predict possible wear of the image capture means.

Advantageously, the outcomes of the classification methods of the tablet introduced into the machine during its operational life may be communicated over time to external management systems, temporarily associated through a local wired link or a remote wireless link, such as by means of a local or wide communication network, from which the microcontroller unit may receive programming instructions, such as updating characteristic parameters of the classification model.

In the pre-chamber, which is in communication with the infusion chamber, there may be vapor from the infusion chamber, represented in the image by the pictogram indicated by V, and the pre-chamber may then preferably be associated with fan means 92 for cleaning the detector device 62 integrated in the image acquisition and recognition module 88, e.g., for the aspiration of the vapor or suspended precursor material particles produced by previous infusion operations and the subsequent cleaning of the optics of the imaging device, these fan means 92 being controlled by a relevant electronic control module 94.

Finally, reference numeral 96 denotes a module for managing the electrical power supply to the system components.

Of course, without prejudice to the principle of the invention, the embodiments and the details of execution may vary widely with respect to that which has been described and illustrated purely by way of non-limiting example, without thereby departing from the scope of protection of the invention defined by the appended claims.

1. A tablet for extraction of a beverage, formed by cohesion of a dosed amount of at least one precursor substance in granular or powder form, said tablet having at least one reference surface with one or more graphic recognition markings, wherein said one or more graphic recognition markings are adapted to provide protection from abrasion of the precursor substance in a region in which said one or more graphic recognition markings are formed compared to a region of the at least one reference surface of the precursor substance which is devoid of said one or more graphic recognition markings.

2. The tablet of claim 1, wherein said one or more graphic recognition markings are adapted to determine a greater degree of cohesion of the precursor substance in the region in which said one or more graphic recognition markings are formed compared to the region of the at least one reference surface of the precursor substance which is devoid of said one or more graphic recognition markings.

3. The tablet of claim 1, wherein said one or more graphic recognition markings comprise two-dimensional graphic recognition markings.

4. The tablet of claim 3, wherein said two-dimensional graphic recognition markings comprise a deposition track of an additional substance that is edible or is for food use on the at least one reference surface.

5. The tablet of claim 3, wherein said two-dimensional graphic recognition markings comprise a hot marking track of the at least one reference surface.

6. The tablet of claim 3, wherein said two-dimensional graphic recognition markings comprise a track of application of a localized laser beam on the at least one reference surface.

7. The tablet of claim 1, wherein said one or more graphic recognition markings comprise three-dimensional graphic recognition markings.

8. The tablet of claim 7, wherein said three-dimensional graphic recognition markings comprise raised graphic recognition markings on the at least one reference surface of the tablet.

9. The tablet of claim 8, wherein said raised graphic recognition markings comprise a deposition track of an additional substance that is edible or is for food use on the at least one reference surface.

10. The tablet of claim 7, wherein said three-dimensional graphic recognition markings comprise graphic recognition markings engraved on the at least one reference surface of the tablet.

11. The tablet of claim 10, wherein said graphic recognition markings engraved on the at least one reference surface of the tablet comprise a track obtainable by mechanical and/or thermal impression on predetermined areas of the at least one reference surface.

12. The tablet of claim 1, wherein said one or more graphic recognition markings exhibit at least one of a color different from a color of the at least one reference surface, a color contrasting with the color of the at least one reference surface and a light intensity or brightness different from a light intensity or brightness of the at least one reference surface in response to an illumination of the at least one reference surface.

13. The tablet of claim 8, wherein said raised graphic recognition markings exhibit modified reflection properties and/or shadows in response to an illumination of the at least one reference surface.

14. The tablet of claim 4, wherein said additional substance that is edible or is for food use is adapted to separate from the precursor substance of the tablet under infusion conditions to enter a beverage composition.

15. A method for producing a tablet for extraction of a beverage, wherein said tablet is formed of a dosed amount of at least one precursor substance in granular or powder form, the method comprising steps of:
forming a body of the tablet having a self-supporting structure; and
making graphic recognition markings on a reference surface of said body of the tablet, which are adapted to provide protection from abrasion of the precursor substance in a region of the reference surface in which said graphic recognition markings are formed compared to a region of the reference surface of the precursor substance which is devoid of said graphic recognition markings.

16. The method of claim 15, wherein the step of making the graphic recognition markings comprises making graphic recognition markings adapted to determine a greater degree of cohesion of the precursor substance in the region in which said graphic recognition markings are formed compared to the region of the reference surface of the precursor substance which is devoid of said graphic recognition markings.

17. The method of claim 15, wherein the step of making graphic recognition markings comprises making two-dimensional graphic recognition markings.

18. The method of claim 17, wherein making the two-dimensional graphic recognition markings comprises depositing a track of an additional substance which is edible or is for food use on the reference surface.

19. The method of claim 17, wherein making the two-dimensional graphic recognition markings comprises hot marking said two-dimensional graphic recognition markings on the reference surface.

20. The method of claim 17, wherein making the two-dimensional graphic recognition markings comprises applying a localized laser beam on the reference surface.

21. The method of claim 15, wherein the step of the making graphic recognition markings comprises making three-dimensional graphic recognition markings.

22. The method of claim 21, wherein the making three-dimensional graphic recognition markings comprises making raised graphic recognition markings on the reference surface of the tablet.

23. The method of claim 22, wherein making the raised graphic recognition markings comprise depositing a track of an additional substance which is edible or is for food use on the reference surface.

24. The method of claim 21, wherein making the three-dimensional graphic recognition markings comprises engraving said graphic recognition markings on the reference surface of the tablet.

25. The method of claim 24, wherein engraving said graphic recognition markings on the reference surface of the tablet comprises mechanically and/or thermally imprinting a track on predetermined areas of the reference surface.

26. The method of claim 15, comprising making graphic recognition markings exhibiting at least one of a color different from a color of the reference surface, a color contrasting with the color of the reference surface and a light intensity or brightness different from a light intensity or brightness of the reference surface in response to an illumination of the reference surface.

27. The tablet of claim 10, wherein the graphic recognition markings engraved on the at least one reference surface exhibit modified reflection properties and/or shadows in response to an illumination of the at least one reference surface.

28. The tablet of claim 9, wherein said additional substance that is edible or for food use is adapted to separate from the precursor substance of the tablet under infusion conditions to enter a beverage composition.
